(19) United States
(12) Patent Application Publication
(10) Pub. No.: US 2008/0226780 A1
(43) Pub. Date: Sep. 18, 2008

(54) Frozen Microwavable Bakery Products

(75) Inventors: Harry K. Kraklow, Eau Claire, WI (US); Cynthia R. Kandler, Chippewa Falls, WI (US)

Correspondence Address: FISH & RICHARDSON P.C., PO BOX 1022, MINNEAPOLIS, MN, 55440-1022, US

(73) Assignee: First Products, Inc., a Minnesota corporation

(21) Appl. No.: 12/124,730

(22) Filed: May 21, 2008

Related U.S. Application Data
(62) Division of application No. 10/974,379, filed on Oct. 27, 2004.
Application No. 10/974,379 is a continuation of application No. PCT/US03/13368, filed on Apr. 29, 2003.
(60) Provisional application No. 60/376,068, filed on Apr. 29, 2002.

(51) Int. Cl. A21D 8/06; A23L 1/025

(52) U.S. Cl. 426/243

(57) ABSTRACT

A frozen microwavable bakery product having an open grain structure including from about 40 to about 58% by weight of a cereal grain flour having high protein content. The bakery product has a yeast leavened bread dough matrix including from about 4 to about 8 weight percent of a blend of sweeteners including water activity reducing agents effective to bind water within the bakery product to reduce the amount of free moisture in the bread dough matrix and minimize sublimation of moisture in frozen storage. Preferred embodiments can contain an enrobed portion containing a food or foods. Methods of making the frozen microwavable bakery products are also disclosed including a step of freezing the products for frozen storage following proofing the products to a rise of about 30 to about 35% of the actual projected leavening capacity.

### CROSS-REFERENCE TO RELATED APPLICATIONS

The present application is a divisional application of and claims priority to U.S. application Ser. No. 10/974,379, filed on Oct. 27, 2004, which claims priority to U.S. Provisional Patent Application No. 60/376,068 filed Apr. 29, 2002, through co-pending PCT Application No. PCT/US03/13368 filed Apr. 29, 2003, all of which are incorporated by reference in their entirety herein.

### TECHNICAL FIELD

The present invention relates to frozen microwavable bakery products, particularly bread products, and methods of making such products. A frozen bread dough composition which is bakeable directly from the frozen state is also provided.

### BACKGROUND

Grain-based baked products, such as breads, have been a food staple for man since biblical times. Some type of finely ground grain is combined with additional ingredients, such as sweeteners, eggs, fats, milk, etc., and the resulting dough is baked to produce a baked product with moderate storage stability.

Generally, such a dough mixture is freshly prepared from the selected ingredients shortly before baking.

Food scientists have developed refrigerated dough products available from the refrigerated section at grocery stores in the U.S., but these products often require proofing prior to baking, and they are not generally frozen products. The frozen bread dough products that are believed to exist require thawing and also require proofing before they can be baked. Such frozen dough products are widely available to the consumer, but they often command premium prices. These products are specially formulated to survive freezing and thawing while still producing a baked food product acceptable to consumers. Generally, frozen bread dough is thawed to ambient temperature and then is allowed to rise (proof) at a non-baking temperature somewhat above normal ambient temperatures to provide an expanded open grain dough structure that is baked in an oven to produce a suitable finished product. The time allowed for the thawed dough to rise or proof is termed the “slack time” in the baking industry.

Variations in these procedures have been developed to shorten the overall bread-making process. The manufacturer may allow the freshly made dough to rise, then partially bake or “par bake” the item to set the dough structure. The par baked product is then frozen for distribution to consumers who finish baking the par baked product just prior to consumption. These are the well-known “brown-and-serve” baked bread products.

Freezing breads and other bakery products is generally problematic because a number of physical changes occur during frozen storage of foods. Among these are changes involving growth in the average size of ice crystals mostly due to temperature fluctuations during storage.

Moisture migration also may be a problem during storage of frozen foods. Temperature gradients or differences will exist in a product due to temperature fluctuations. Water vapor pressure will be higher at higher temperatures than at lower temperatures, and moisture will relocate to the colder area(s) particularly at the surface or when there is a space or void. For this reason, moisture often will accumulate on the product surface. If, and when the temperature gradient reverses, the moisture will not migrate back to its original location.

This same mechanism is responsible for the “freezer burn” that can occur when frozen foods are poorly wrapped. In this case, moisture migrates through the packaging material and disappears through sublimation leaving the product dried out.

Other changes that can occur in frozen foods are precipitation of solute from the unfrozen phase due to supersaturation, protein insolubilization due to cross-linking, polymer aggregation, lipid oxidation and pigment changes caused by oxidation or hydrolysis.

Bakery products offer special problems because of accelerated staling and moisture loss. Staling rate increases as temperature decreases until the aqueous phase is frozen and starch can no longer crystallize. In order to prevent staling it is necessary to bring the product through the temperature zone of +10° C. (50 degrees Fahrenheit) to −5° C. as rapidly as possible during the freezing process itself.

Various enrobed food products have been developed which combine a bread dough covering a filling material. When the enrobed food product is frozen, the product requires a “slack time” to allow the frozen dough portion to rise prior to baking in order to produce an acceptable finished bread product. Some examples of dough and similar food product compositions for which patents have been granted include the following.

Thelin (U.S. Pat. No. 3,479,188) discloses a process for heating a dough with microwave energy to expand and set the structure, freezing the item for storage, then deep fat frying the thawed item to brown its surface.

Zimmerman (U.S. Pat. No. 3,532,510) discloses unbaked filled rolls packaged in a container for refrigerated storage. A filling is placed between two sheets of dough, and the sheets are sealed together to encase the filling. The separated units are later baked to produce a finished product.

Colvin (U.S. Pat. No. 3,539,354) discloses a frozen sandwich made from baked bread and selected fillings. The bread surfaces of the frozen sandwich contact the metallic surfaces of the storage container so the bread is browned during oven heating to prepare the sandwich for eating.

Blaetz et al. (U.S. Pat. No. 3,719,138) disclose another frozen sandwich made from baked bread and selected fillings. The frozen sandwich is treated with moisture to prevent browning during the heating of the frozen sandwich prior to consumption.

Woods (U.S. Pat. No. 4,015,085) discloses a frozen sandwich container for microwave heating of the contained sandwich. The container has a conductive metallic layer on the interior bottom to apply heat to the frozen bread of the sandwich during heating.

Forkner (U.S. Pat. No. 4,020,188) discloses a food product having an inner filling of frozen dessert and an outer layer of cooked dough. The filling is enclosed in a layer of dough with an inner layer forming a protective backing. The product is cooked so the outer dough layer is cooked without modification of the filling. The product before cooking can be stored under refrigeration and marketed as such.

Forkner (U.S. Pat. No. 4,068,007) discloses a method for making a seasoning-containing confection wafer that can be added to a sandwich, such as a hamburger or cheeseburger, without adding sweetness to the overall taste.

Vermilyea et al. (U.S. Pat. No. 4,207,348) disclose a sandwich-like food item for microwave heating produced by inserting a prefrozen layer of interior filling material into a dough envelope, then proofing and baking the sandwich-like item. The formulation of the dough, the total enveloping of the filling, and the cold state of the filling during proofing and baking contributes to the resistance to adverse effects from microwave heating. The baked product can be frozen and reheated later.

Munter et al. (U.S. Pat. No. 4,265,919) disclose a food product prepared by filling a container with fluid filling and covering the container with a sheet of dough. The unit is frozen and, at a future time, the unit is baked to form a crust and fluid filling. The unit is inverted to allow the crust to contain the fluid filling when the container is removed.

Tobia (U.S. Pat. No. 4,313,961) discloses a complete meal food product that includes a flat sheet of dough with pasta and meat on the dough sheet. The combination is baked and can be eaten as a sandwich by rolling up the baked dough sheet containing the other items.

Larson et al., (U.S. Pat. Nos. 4,406,911 and 4,450,177) disclose a method of producing and baking frozen yeast leavened dough. The yeast containing dough is prepared at ambient temperature, fermented and proofed, frozen, and finally baked, starting from a cold oven, for about one hour. The dough formulation is provided for dough stored for short (four weeks) and long (eight weeks) periods of time.

Nourigeon (U.S. Pat. No. 4,414,228) discloses preparing a high gluten frozen bread dough using yeast that is stabilized by deep freezing prior to incorporation into the dough composition. The duration of mixing of the ingredients is minimized to maintain minimum dough temperature. The dough is frozen in a water saturated atmosphere to coat the dough with a layer of ice. The dough is thawed and proofed before baking.

Hong et al., (U.S. Pat. No. 4,693,899) disclose a filled cooked dough product prepared by enclosing a raw dough around a viscous cooked meat/sauce interior. The product is cooked to develop the dough to a firm crust. The partially cooked item is frozen and then reheated to a finished product by microwave heating.

Brooks et al. (U.S. Pat. No. 4,741,908) disclose an enrobed food product having improved freezer shelf-life. The inner filling material is prefrozen and shaped to be smooth surfaced and devoid of edges. The dough, termed a farinaceous dough, is a composite dough having fats or margarine interposed between dough layers. The composite dough showed improved performance compared to a nonlaminated bread-like dough in freezer shelf-life studies.

Peleg (U.S. Pat. No. 4,841,112) discloses a container and susceptor plate for microwave cooking of frozen pot pies.

Cochran et al. (U.S. Pat. No. 4,957,750) disclose an improved dough composition for baked goods that retains palatability upon microwave heating. The composition includes small amounts of a protein modifier which contains free sulphydryl groups. L-cysteine is the preferred protein modifier.

Sluimer (U.S. Pat. No. 5,094,859) discloses preparing bread dough, including fermentation and all proofing, freezing the formed dough and baking it at a later time. Alcohol is added to the initial dough mixture to improve the finished product. No specific dough composition is disclosed.

Kasahara et al. (U.S. Pat. No. 5,262,182) disclose a dough conditioner used to improve bread made from frozen dough. The conditioner incorporated into the dough composition includes an ascorbic acid, one or more amino acids or salt of cystine, methionine, asparagic acid, alanine or glycine, an alum, and an emulsifier such as glycerol fatty acid monoester or sucrose fatty acid esters. A final proofing period for the defrosted dough is used prior to baking.

Schwartz (U.S. Pat. No. 5,312,633) discloses a stuffed pretzel dough product and a completed stuffed pretzel product. The pretzel dough is prepared from spring wheat flour and used to encase a filling material, such as meat or cheese. The stuffed pretzel can be refrigerated for storage and later baked at 550° F. for from about 8 to about 10 minutes. Convection or microwave heating is also mentioned.

Thus, there is an unmet need for frozen bread dough products that can be placed in the frozen state directly into a baking oven, such as a microwave oven, without “slack time,” and then produce a baked food product that is acceptable to consumers. In addition, it will be appreciated that many of the aforementioned frozen products become less desirable during frozen storage as ice crystals recrystallize and grow larger in size. Furthermore, water loss from sublimation during frozen storage can reduce the amount of moisture remaining in the fully prepared bakery product, making such products undesirable.

### SUMMARY

The present invention preferably provides a frozen microwavable bakery product having an open grain structure including from about 40 to about 58% by weight of a cereal grain flour, preferably having a high protein content of from about 12 to about 16% by weight protein in order to provide sufficient structure to result in a leavened bread dough having an open grain structure similar to that normally associated with other breads; from about 2.0 to about 7.0% by weight of baker's yeast to leaven the bakery products; from about 0.5 to about 1.0% by weight salt; from about 0.5 to about 3.0% by weight granulated sugar (sucrose); from about 0.5 to about 1.5 weight percent of an emulsifier; from about 1.0 to about 4.25% by weight of a shortening; from about 0.2 to about 1.5% by weight of a food grade oil, from about 4 to about 8 weight percent of a blend of sweeteners including water activity reducing agents effective to bind water within the bakery product to reduce the amount of free moisture in the dough product and minimize sublimation of moisture in frozen bakery products when stored in frozen storage; and about 25 to about 60% by weight of water. In preferred embodiments the frozen microwavable bakery product will preferably include from about 1.8 to about 2.35 weight percent encapsulated sodium bicarbonate (50% sodium bicarbonate); from about 1.0 to about 1.5 weight percent of a dough enhancing additive for frozen microwavable dough products; from about 2.0 to about 6.0% by weight of flavoring components; from about 0.5 to about 1.5% by weight of a further leavening agent, preferably either double acting baking powder or sodium aluminum phosphate (SALP); and from about 0.01 to about 0.20% by weight of a dough conditioner.

In preferred embodiments, the present invention provides a frozen microwavable bakery product including from about 40 to about 58, preferably from about 42 to about 56% by weight of a cereal grain flour, preferably having a high protein content of from about 12 to about 16% by weight protein in order to provide sufficient structure to result in a leavened bread dough having an open grain structure similar to that normally associated with other breads. In preferred embodiments, the present invention will include from about 2.5 to about 5.0, more preferably from about 3.0 to about 4.5% by weight baker's yeast to leaven the bread dough. Preferred embodiments will also include from about 0.5 to about 1.0% by weight salt; from about 0.5 to about 1.0% by weight granulated sugar (sucrose); from about 1.8 to about 2.35 weight percent encapsulated sodium bicarbonate (50% sodium bicarbonate) as a further chemical leavening agent; from about 1.0 to about 1.5 weight percent of a dough enhancing additive for frozen microwavable dough products; from about 2.0 to about 6.0% by weight of flavoring components; from about 0.5 to about 1.5% by weight of a further leavening agent, preferably either double acting baking powder or sodium aluminum phosphate (SALP); from about 0.01 to about 0.20 of a dough conditioner; from about 0.5 to about 1.5 weight percent of an emulsifier; lactylate hydrate; from about 1.0 to about 3.0% by weight of shortening; from about 0.2 to about 1.0% by weight of a food grade oil; from about 4 to about 6 weight percent of a blend of sweeteners including water activity reducing agents effective to bind water within a formulated dough product to reduce the amount of free moisture in the dough product and minimize sublimation of moisture in frozen bakery products when stored in frozen storage; and about 25 to about 40% by weight of water. In preferred embodiments, the blend of sweeteners will include from about 40 to about 90, preferably from about 50 to about 85, more preferably from about 60 to about 80, most preferably about 70% by weight of corn syrup. Although other sweeteners such as sucrose, fructose and other diglycerides and other oligosaccharides are active water activity reducing agents, corn syrups of all kinds are especially good water activity reducing agents and provide significant water activity reduction at a minimal cost.

It is an object of the present invention to provide a frozen microwavable bread product which is partially proofed to allow the bread to rise as a result of the leavening provided by less than about half of the yeast leavening capacity in the dough prior to freezing and storage in frozen storage. The preferred product is then cooked either in a microwave oven or by other conventional cooking systems without a need for thawing or further proofing prior to being cooked. The finished bakery product will continue to rise during microwave cooking or other conventional cooking processes. In preferred embodiments, a caramel coloring may be added in an amount of from about 0.2 to about 0.8% by weight to provide for an enhancement of natural browning reactions during cooking.

In preferred embodiments, the frozen microwavable bread product will be cooked in a microwave without the need for susceptor packaging materials in close association with the product during microwave cooking but may simply be cooked in packaging including common white SBS board which is believed to cost only a fraction of the expense required for the purchase of well-known susceptor board products commonly used for packaging microwavable food products.

It is an object of the present invention to provide a frozen microwavable enrobed sandwich product enrobed in a preferred sandwich dough of the present invention wrapped around and preferably enclosing other foods such as meats, cheeses, tomato sauces, vegetables, condiments and the like incorporated within the enrobed sandwich product.

A further embodiment of the invention is directed to a frozen bread dough composition that is bakeable from the frozen state to a finished product without intervening slack time. The dough includes a structure providing amount of flour and a source of sugar, including a fluid corn syrup. The dough contains an effective amount of yeast to provide a finished product of desired density. There is an amount of shortening effective to enhance the organoleptic properties of the dough, and an effective amount of emulsifier preventing component separation is present. The dough contains an effective amount of conditioner to provide extensibility to the dough, and an effective amount of microwaveability enhancer to improve the reheating characteristics of the frozen dough is present. The dough also includes an effective amount of an encapsulated leavening agent to provide the finished product a desired density, and an effective amount of preservative to prevent microbial and mold growth in the dough is present. The dough is stable under freezer temperature conditions and bakes from a frozen state directly to a bread consistency without slack time, using either microwave energy or convection/conventional oven heating.

In a further embodiment of the invention, a precooked filling item or items such as meat, vegetables, cheese, tomato sauces and the like are enrobed in the above-described raw bread dough. The filling enrobed with dough is frozen for distribution and baking prior to consumption at a later time. Again, either microwave energy or convection/conventional oven heating is suitable for heating the dough enrobed food item.

It is a further object of the invention to provide a frozen microwavable bakery product having a bread dough matrix in which moisture is significantly bound by a combination of water activity reducing sweeteners, other water activity reducing agents such as emulsifiers and also ionic substances such as salt. In preferred embodiments, these substances will make up at least about 2.5, preferably about 3.0, more preferably about 3.5, even more preferably about 4.0, even more preferably about 4.5, even more preferably about 5.0, and even more preferably about 5.5% by weight of the bread dough matrix will be a combination of these water activity reducing sweeteners, agents and salts. In a most preferred embodiment, 5.65% by weight of the bread dough matrix is a combination of water reducing sweeteners, agents and salts which will significantly enhance the water binding capacity of the bread dough matrix so that, upon being frozen and being stored in frozen storage, the migration of the moisture within the frozen bread dough matrix will be minimized, as will the sublimation of such moisture during such storage, so as to provide a more desirable bakery product upon heating following frozen storage, whether by means of a microwave oven or other cooking means.

It is a further object of the present invention to provide a frozen microwavable bakery product in which a portion of the leavening capacity of the bread dough matrix is activated during a proofing step prior to freezing. In preferred embodiments, freezing is accomplished very quickly, preferably from about 30 seconds to about 20 minutes, more preferably from about 30 seconds to about 10 minutes, and most preferably from about 30 seconds to about 3 minutes, although the size and weight of the bakery product will limit the effectiveness of the freezing operation in this regard. It will be appreciated, however, that it is an object of the present invention to provide a freezing process which is very rapid to further enhance the quality of the bakery product following frozen storage.

A further object of the present invention is to provide a frozen microwavable bakery product in which the step of proofing the bread dough matrix prior to freezing utilizes only a portion, preferably only about 20 to about 60, more preferably only about from about 30 to about 40% of the leavening capacity of the bread dough matrix and/or allows a rise of from about 20 to about 60, preferably from about 30 to about 40% of the projected rise resulting from the leavening process, prior to freezing such that upon heating the bread dough matrix after frozen storage, whether by microwave cooking or other cooking processes, causes a further rise of from about 80 to about 40, preferably from about 70 to about 60% of the projected rise of the bread dough matrix caused by the leavening capacity of the bread dough matrix.

In preferred embodiments, a frozen microwavable bakery product is provided, including a leavened, open grain bread dough matrix made by mixing dry ingredients including from about 40 to about 58% of a cereal grain having a protein content of from about 12 to about 16% by weight; from about 2 to about 7% of baker's yeast, from about 0.5 to about 1.0% by weight salt, and from about 0.5 to about 3% by weight granulated sucrose; liquid ingredients including from about 0.5 to about 1.5 weight percent of an emulsifier and from about 4 to about 8 weight percent of a blend of sweeteners including water activity reducing agents effective to bind water; and from about 25 to about 60% by weight of water.

In a further embodiment of the present invention the aforementioned microwavable bakery product is made by a method comprising the steps of forming a leavened, open grain bread dough matrix by mixing the aforementioned dry ingredients, liquid ingredients and water; wherein the step of mixing includes sequentially mixing, first the cereal grain flour and the baker's yeast; then adding and mixing the other dry ingredients; then adding and mixing the liquid ingredients; then incrementally adding and simultaneously mixing in the water to form the bread dough matrix, wherein the yeast provides the bread dough matrix with a first leavening capacity. After the dough mixture is extensible, cutting and rounding the dough mixture into dough segments, proofing the dough segments at from about 105 to about 128° F. at a relative humidity of from about 40 to about 60% relative humidity for from about 10 to about 30 minutes; and freezing the dough segments following proofing by reducing the temperature of the dough segments to at least about 0° F. or less in a period of time of from about 30 seconds to about 20 minutes, wherein the dough segments are then retained in frozen storage until heated by cooking the dough segments; wherein the step of freezing is commenced at a time that is projected to freeze the dough segments so that the bread dough matrix has a second leavening capacity remaining after frozen storage that is equal to from about 50 to about 80% of the first leavening capacity.

The above-described features and advantages, along with various other advantages and features of novelty are pointed out with particularity in the claims of the present application annexed hereto and forming a part hereof For a better understanding of the invention, however, its advantages and objects attained by its use, reference should be made to the accompanying descriptive matter in which there is illustrated and described preferred embodiments of the present invention.

### DETAILED DESCRIPTION

As noted above, the various frozen bread dough presently available to consumers requires slack time to rise prior to baking. Applicants have invented a bread dough composition which can be baked directly from the frozen state using microwave energy baking, conventional oven baking or convection oven baking. The dough is bakeable as a stand-alone bread product, or the dough can enrobe a precooked filling, thereby producing a hot finished food product having a bread covering the heated filling. Also disclosed is a method of preparation of the bread dough composition of the present invention that is bakeable from the frozen state.

The bread dough of the present invention contains a flour component that contributes to the structure of the bread dough, including the texture, taste and appearance of the final baked product. Useful flours include hard wheat flour, soft wheat flour, barley flour, high amylose flour and low amylose flour. In certain preferred embodiments, the flour used for the bread dough composition of the present invention is a high gluten flour used in many bread dough compositions. The bread dough preferably contains from about 45 to about 62, preferably from about 50 to about 58, more preferably from about 52 to about 56 weight percent flour and, most preferably, about 54 weight percent flour. In preferred frozen microwavable bakery products of the present invention, the flour will include from about 11 to about 16, preferably from about 12 to about 15 and most preferably about 13 weight percent of protein. It is believed, but not relied upon, that this higher protein content permits better structural integrity of the dough matrix during the various phases of preparation and baking which results in a superior open grain structure in the preferred frozen microwavable bakery products of the present invention.

Certain preferred bread dough products of the present invention used to prepare certain preferred frozen microwavable bakery products of the present invention contain a yeast component that provides the primary leavening action both during proofing prior to freezing and during heating or baking of the dough. The yeast component can be any commercially available baking yeast sold in dry powder form or solid chunks. Preferably, the yeast component is present at from about 3.0 to about 4.0, most preferably about 3.25% by weight in the bread dough.

In preferred embodiments, the present invention provides a frozen microwavable bakery product including from about 40 to about 58, preferably from about 42 to about 56% by weight of a cereal grain flour, preferably having a high protein content of from about 12 to about 16% by weight protein in order to provide sufficient structure to result in a leavened bread dough having an open grain structure similar to that normally associated with other breads. In preferred embodiments, the present invention will include from about 2.5 to about 5.0, more preferably from about 3.0 to about 4.5% by weight baker's yeast to leaven the bread dough. Preferred embodiments will also include from about 0.5 to about 1.0% by weight salt; from about 0.5 to about 1.0% by weight granulated sugar (sucrose); from about 1.8 to about 2.35 weight percent encapsulated sodium bicarbonate (50% sodium bicarbonate); from about 1.0 to about 1.5 weight percent of a dough enhancing additive for frozen microwavable dough products (preferably a specialty product from the Specialty Products Division of Brechet & Richter Co., Minneapolis, Minn., called Mikro Fresh™ dough additive); from about 2.0 to about 6.0% by weight of flavoring components; from about 0.5 to about 1.5% by weight of a further leavening product, preferably either double acting baking powder or sodium aluminum phosphate (SALP); from about 0.01 to about 0.20 of a dough conditioner, preferably a product from Watson Foods Co., Inc., Westhaven, Conn. called Relax-A-Do 2 No. F145065; from about 0.5 to about 1.5 weight percent of an emulsifier, preferably EMG/SSL blend (F230100) from Watson Foods Co., Inc., Westhaven, Conn., which includes ethoxylated mono- & diglycerides, and sodium stearoyl lactylate; lactylate hydrate (from Custom Ingredients, Ltd. containing ethoxylated monoglycerides, and hydrated sodium stearoyl lactylate) and the like; from about 1.0 to about 3.0% by weight of shortening, preferably partially hydrogenated shortening such as all-purpose shortening, product code no. 101-050 from Archer Daniels Midland Co., Decatur, Ill.); from about 0.2 to about 1.0% by weight of a food grade oil, preferably soybean oil of the type sold by Columbus Foods Company, Chicago, Ill., under the CFC code no. 100 soybean oil (U); from about 4 to about 6 weight percent of a blend of sweeteners including water activity reducing agents effective to bind water within a formulated dough product to reduce the amount of free moisture in the dough product and minimize sublimation of moisture in frozen bakery products when stored in frozen storage, the preferred blend including from about 30 to about 100% by weight of corn syrup and the like and from about 0 to about 70% by weight of an aqueous mixture of a disaccharide such as sucrose disaccharide sugar moieties (preferably a liquid pizza blend containing about 63% 36 DE corn syrup, about 8% by weight high fructose, about 28% by weight of liquid sucrose and about 4% by weight of imitation vanilla; and about 25 to about 40% by weight of water.

The blend of sweeteners including water activity reducing agents, preferably water activity reducing sweeteners, effective to bind water within a formulated dough product to reduce the amount of free moisture in the dough product and minimize the sublimation of moisture in frozen bakery products when stored in frozen storage is preferably present in frozen microwavable bakery products of the present invention at from about 4 to about 8% by weight, more preferably from about 4 to about 6% by weight. In preferred embodiments, this blend of sweeteners will include from about 30 to about 100, preferably from about 40 to about 90, even more preferably from about 60 to about 80, most preferably about 70% by weight of corn syrups and the like. This blend of sweeteners may also include from about 0 to about 70, preferably from about 10 to about 50, more preferably from about 20 to about 40, even more preferably about 30% by weight of a liquid diglyceride, preferably liquid sucrose which is preferably from about 75 to about 85, preferably 80% by weight sucrose in an aqueous solution. In preferred embodiments, the sweetener may also contain a flavoring component such as vanilla, imitation vanilla, and other similar flavoring components having an aqueous/alcohol solvent base. In preferred embodiments, imitation vanilla is included. This flavoring component may be present in the blend of sweeteners in an amount from about 0 to about 10, preferably from about 0.5 to about 8, more preferably from about 2 to about 6, most preferably about 4% by weight. In the most preferred embodiment of the blend of sweeteners, a product further referenced herein as liquid pizza blend, or the liquid pizza blend formulation, the blend of sweeteners will include the following: 63% by weight 36 de corn syrup; 8% by weight of a light corn syrup, preferably high fructose 42 corn syrup, 28% by weight liquid sucrose and 4% imitation vanilla.

In this document, the following terms will have the following general meanings:

Water Activity Reducing Agents, including water activity reducing sweeteners, are agents which interact through a variety of chemical interactions roughly described as bonding, with water, to reduce the ability of the water to migrate within a complex mixture such as a food matrix within a food product. These water activity reducing agents also reduce the degree to which water will sublimate within a frozen food product during frozen storage. Although salt and other inorganic ionic salt species also reduce water activity, within the present context provided by the present application, these agents are not considered water activity reducing agents.

Carmelization: The thermal transition of sugar, as occurs in the production of caramel or the browning of the crust in bakery products during baking. It proceeds in a series of reactions that convert the sugar into complex compounds that vary in color from pale yellow to dark brown, and changing taste from sweet pleasant to acrid and bitter.

Double Acting Baking Powder: A baking powder that contains both slow and fast reacting leavening acids. Products containing such a baking powder will receive some aeration during preparation but most during the baking process when it is required most.

Emulsifier: A surface active substance with affinity to both water and lipids and therefore, in food, has the ability to form an emulsion from two immiscible liquids. It achieves this by reducing the surface tension of both components. Typical emulsifiers include monoglycerides and diglycerides, DATEM, Sodium Stearoyl-2-Lactylate and the like. It will be appreciated that emulsifiers including a plurality of hydroxyl groups that can interact or bind water are also water activity reducing agents. The following emulsifiers are water activity reducing agents and may be used in preferred or, perhaps, alternate embodiments of the present invention: sodium stearoyl-2 lactylate (SSL); calcium stearoyl-2 lactylate (CSL), ethoxylated monoglycerides (EOM); Datem; sucrose esters; polysorbate 60; mono- & diglycerides; succinylated monoglycerides; lecithin; lactylate hydrate, and the like.

DATEM: An emulsifier, diacetyl tartaric esters of mono- and diglycerides. The main emulsifier for crusty bread as when used in a fermented dough it improves dough tolerance, gas retention, loaf volume and crustiness.

Proofing: In bread baking, this term indicates the period of time during which leavening is initiated and a product is allowed to rise after it is shaped and placed on or in pans or the like. Products are commonly proofed until doubled in size, or when a finger, lightly placed on the side of the loaf, leaves an indentation, but a product can be “proofed” for only a fraction of the time necessary for this to occur. Products are generally “proofed” in a humid, draft-free environment at a temperature of from about 105 to about 128, preferably from about 108 to about 120, more preferably from about 110 to about 115° F.

Rounding: Usually applied to the first mold. The pre-weighed dough piece is processed into a ball shape with a smooth, dry outer surface. This helps minimize subsequent gas diffusion from the dough and also prepares the dough to make the final molding (shaping) more consistent.

Salt: Sodium Chloride (NaCl). Salt is a multi-functional ingredient in the baking industry. Its uses include: flavor provider and enhancer, control of yeast activity in fermented goods, strengthening gluten in breads, preserving food (curing) and reducing water activity (water available for mould to grow). Although salt is believed to reduce water activity, it is not believed to bind free moisture as water activity reducing agents, including sweeteners, are believed to do. Salt is believed to work indirectly or synergistically with water activity reducing agents to help the product bind free moisture, reduce water migration and minimize frozen product moisture loss due to sublimation during frozen storage. It is not considered, however, to be a per se water activity reducing agent because it dissolves in water to form ionic interactions as opposed to other types of chemical bonds. Salt is believed to be eleven times more effective than sugar in reducing water activity so it is an excellent ingredient for extending the shelf life of cakes. The drawback with its use is that its flavor would be detectable and unacceptable at relatively low levels in cakes.

Sodium Stearoyl-2-Lactylate (SSL): An emulsifier used in bread dough to improve loaf volume, dough tolerance, gluten strength, machinability and crumb softness of the baked bread.

Surfactant: A substance, also referred to as an emulsifier. Common to baking would include monoglycerides, diglycerides, DATEM, Sodium Stearoyl-2-Lactylate. A surfactant will reduce the surface tension of a liquid or solution to which it is to be added.

Water Activity: The ratio of the vapor pressure of moisture in a food to the vapor pressure of water at the same temperature. It is the equivalent to one hundredth of the relative humidity generated by the food within a closed system (e.g. a wrapped cake). Water activity (A.sub.w) measurement is used as a guide to the products susceptibility to microbiological spoilage. High water activities (0.8-0.95) are ideal conditions for mold growth, the common spoilage to many bakery products, especially when wrapped in moisture impermeable materials. When water activities are reduced, moisture loss during frozen storage by sublimation is minimized because the ratio of “free” moisture to “bound” moisture is reduced and bound moisture is not as likely to be lost through sublimation as is free moisture because the ability of bound moisture to migrate is significantly reduced.

Baker's Yeast: A living unicellular plant (saccharomyces cerevisiae); generally comes in a dry package or a “cake”. Contains various enzymes which convert the flour starch into fermentable sugars, which are further broken down into carbon dioxide gas and alcohol. Without yeast dough is generally classed unleavened and will generally have a dense, heavy structure. There are yeast substitutes, however, that can have a leavening like effect. These generally provide “chemical leavening.” Compressed yeast (a yeast “cake”) is the most commonly used form, but yeast is also available as a cream (liquid) which is used by the industrial sector or as a dry powder, active or instant. Active yeast requires re-hydrating with water before use but instant yeast can be added with the other dry ingredients when making fermented dough.

For purposes of this disclosure and the accompanying claims, “water activity reducing sweetener” includes corn syrups of all kinds, monosaccharides and disaccharides in either refined or unrefined forms and includes both granulated and powdered sugar (sucrose), raw sugar, molasses, turbinado sugar, brown sugar, invert sugar and the like. The water activity reducing sweetener incorporated in the dough composition according to the present invention may also include sweeteners such as fructose, dextrose, glycerol, glycerin, maltose, arabinose, sorbitol, maple syrup, corn syrup, molasses, honey, polydextrose, isomalt and the like.

The water activity reducing sweeteners are preferably selected from the group consisting of sucrose, fructose, corn syrup, high DE corn syrup, high fructose corn syrup, glycerine and the like. In this regard, sucrose means any form of sucrose and fructose means any form of fructose. Corn syrup means any food grade syrup sweetener derived from corn (maize). Corn syrup is available in various forms within the industry. Glycerine includes glycerol and other generally small chain carbon alcohols that have similar water activity reducing attributes to those of glycerol, which are also acceptable constituents in food products under the rules and regulations of the United States Food & Drug Administration (FDA). In preferred embodiments, the water activity reducing sweeteners used in the present invention include crystalline fructose, crystalline sucrose and the like. It is believed that, but not relied upon, that these water activity reducing agents bind water to reduce the water activity of the water in a mixture containing any of these water activity reducing sweeteners. It is believed, but not relied upon, that this occurs because the water is more tightly bound and is, therefore, less able to evaporate and less able to freely migrate from or within the product matrix. It is believed, but not relied upon, that this water binding capacity results at least in part from ionic interactions, hydrogen bonding, Vander Walls forces and the like, which occur between the water activity reducing agents and the free water in the product matrix.

Attraction of water to carbohydrates is one of carbohydrates basic and most useful physical properties. Hydrophilicity is expected because of their numerous hydroxyl groups. Hydroxyl groups interact with water molecules by hydrogen bonding, and this leads to solvation and/or solubilization of sugars and many of their polymers. The structure of the carbohydrate can greatly affect the rate of water binding and the amount of water bound.

Impure sugars or syrups generally absorb more water and at a faster rate than pure sugars. This is evident even when the “impurity” is the anomeric form of the sugar, and is even more evident when small amounts of oligosaccharides are present, for example, when malto-oligosaccharides are present in commercial corn syrups.

“Shortening” may include any suitable edible fat or fat substitute in either solid or liquid form at room temperature, including vegetable oil, sunflower oil, safflower oil, cottonseed oil, canola oil, soybean oil, olive oil, coconut oil, and palm oil. As used herein, “shortening” may also include fat substitutes including cellulose, gums, dextrins, maltodextrins, modified food starch, polydextrose, microparticulated protein, protein blends, emulsifiers, lipid analogs, esterified propoxylated glycerol, and sucrose polyesters.

The composition of the bread dough of the present invention preferably includes flour, water, yeast, salt, shortening, oil, corn syrup, sugar, emulsifier, flavoring, encapsulated sodium bicarbonate, baking powdered, dough conditioner, microwaveability enhancer, and preservative.

In a preferred embodiment of the bread dough composition, the flour is a high gluten, bleached, enriched wheat flour, and the sugar includes a mixture of sucrose and fluid corn syrup in a ratio of about 1.00:2.00 by weight. Each of the sugar components is known in the industry and commercially available. The yeast component is preferably present at about 3.25% by weight.

In a preferred embodiment of the bread dough composition, the shortening includes a mixture of solid and liquid shortening in a ratio of about 6.0:1.0 by weight. Most preferably, the solid shortening is a partially hydrogenated vegetable soybean oil and cottonseed oil material. A suitable product is available from Archer Daniels Midland Co., Decater, Ill., and denoted as product code number 101-050. The liquid shortening is most preferably a soybean oil, well known in the food industry and available from numerous suppliers.

The dough conditioner of the bread dough of the present invention preferably decreases mixing time and improves dough extensibility. The dough conditioner preferably includes a mixture of wheat starch, 1-cysteine hydrochloride and ammonium sulfate. A suitable conditioner known as Relax-A-Do 2, designated as F145065, is available from Watson Foods Co., Inc., West Haven, Conn. 06516. The bread dough of the present invention most preferably contains from about 0.2 to about 0.10 weight percent of this dough conditioner.

The preferred emulsifier of the bread dough of the present invention prevents component separation and includes a mixture of ethoxylated mono and diglycerides plus sodium stearol lactylate. A suitable emulsifier known as EMG/SSL Blend, designated as WT-5772, is available from Watson Foods Co., Inc., West Haven, Conn. 06516. The bread dough of the present invention preferably contains from about 0.50 to about 1.5 weight percent of this emulsifier in certain embodiments.

The preferred microwaveability enhancer component of the bread dough of the present invention includes a mixture of enriched bleached flour, cellulose powder, modified food starch, carboxymethyl cellulose, xanthan gum, and vegetable shortening. The component mixture enhances the reheating process of frozen microwavable dough products. A suitable microwaveability enhancer having the above components, known as Mikro Fresh, is available from Brechet and Richter Co., Minneapolis, Minn. 55422. The bread dough of the present invention preferably contains from about 1.0 to 1.4 weight percent enhancer component and, most preferably from about 1.1 to about 1.35 weight percent enhancer component.

In a preferred embodiment of the bread dough composition, the flavoring includes a sourdough flavoring available from Brolite Products, Inc., Streamwood, Ill., 60107, and present at from about 1.6 to about 5.0 weight percent of the bread dough of the present invention.

An encapsulated sodium bicarbonate and a double acting baking powder (sodium carbonate) may also be employed in the preferred embodiment of the bread dough composition. The carbonate and bicarbonate salts function as backup “chemical” leavening systems for the yeast in the raw bread dough. The encapsulated sodium bicarbonate (50% of which is sodium bicarbonate) and baking powder are preferably present in a ratio of 1.0:2.5 by weight. Sodium bicarbonate encapsulated with a solid shortening is well known in the food industry and commercially available from numerous sources, as is baking powder.

The preferred embodiment of the bread dough composition preferably includes about 0.8% salt by weight, as, among other things, a preservative effective in preventing bacterial degradation or molding of the bread dough during prolonged storage at freezer temperature. Most preferably, a further the bacterial and mold inhibitor is a mixture of ascorbic acid and calcium iodate in a ratio of about 4.0:1.0 by weight, and present at about 0.27% by weight in the dough composition. Ascorbic acid and calcium iodate are widely known in the food industry and readily available from suppliers. Other antimycotic agents which may inhibit the growth of undesirable bacteria, yeasts and/or molds in the dough composition may also include potassium sorbate, salts of acetic acid, salts of propionic acid, salts of lactic acid, salts of citric acid, calcium phosphate and the like.

The balance of the bread dough is water, preferably present at from about 25 to about 60, more preferably from about 26 to about 40, even more preferably from about 28 to about 34 weight percent. The water provides for an even distribution of all components within the bread dough composition.

Also included in the present invention is a process for preparing the freezable bread dough composition. A commercial mixing machine is employed to mix the ingredients in a single container. The process includes the step of mixing together the flour and other various ingredients with the required amount of water at high speed for about 8 to 10 minutes, until the dough is homogeneous and extensible. The raw dough is then divided into units of the desired size, rounded and proofed to preferably from about 30 to about 35% of the projected total rise, and quick frozen for storage and distribution. Where microwave heating is employed to bake the frozen dough, the dough is sprayed or brushed with an aqueous caramel coloring solution prior to freezing and packaging. A coloring material denoted as Maillose is available from Red Arrow Products Company, Manitowoc, Wis. When heated, the Maillose solution provides a brown, roasted color to the exterior of the baked dough product.

Freezing food has many advantages over other means of preservation, such as thermal processing, because it can provide better organoleptic quality and somewhat better retention of nutrients in the finished product. In addition, most food spoilage organisms cannot grow at frozen food storage temperatures and a reduction in their numbers may actually occur. During freezing, however, moisture in the matrix of frozen open grain bakery product will sublimate while in frozen storage unless efforts are made to bind free moisture to minimize sublimation and loss of such moisture which renders frozen bakery product less and less desirable as moisture loss increases.

There are believed to be several ways to bind moisture in bakery products to prevent them from sublimating. The most prominent way is to reduce water activity relative to the amount of free moisture in the product. This can be accomplished by adding large amounts of water activity reducing sweeteners and other water activity reducing agents. It is believed that these agents will interact with water to reduce the degree to which water is free to migrate, which will reduce the moisture loss during frozen storage. Using flash freezing methods is also believed to reduce the degree of moisture loss as is subzero product storage.

To optimize moisture retention and product quality, the following is believed to be of importance. One of the desired effects of freezing is that water is made unavailable for the growth of microorganisms by being in the form of ice. When water freezes, however, it expands by 9% in volume while forming ice crystals that vary in size depending on the rate of freezing (i.e., slow freezing gives large crystals, often times more structural disruptive, whereas fast freezing results in smaller crystals that are believed to be less disruptive). If such crystals are too large, they may damage the open grain structure of the bakery product.

The addition of a soluble component to water results in a depression of the freezing point. Whereas water alone will freeze at 0° C. (32 degrees Fahrenheit), the addition of a mole (molecular weight of a compound expressed in grams) of a substance will depress the freezing point of the solution by 1.86° C. under ideal conditions. A food can be thought of as a multi-component solution of various sugars, salts, carbohydrates, proteins, fibers, etc. in water.

Foods are complex systems containing many dissolved components and thus behave quite differently than pure water when frozen. As the temperature of a two-component system drops, the number of ice crystals increases while the concentration of the dissolved component, the solute, also increases. In the case of a food, as the concentration of various solutes increases, the system becomes more reactive.

As the temperature drops further, the food reaches a point at which no unfrozen solution exists. This is called the eutectic point. For a sugar and water solution, the eutectic point is −9.5° C.

Being complex systems, most foods have much lower eutectic points that often cannot be achieved with commercial freezing. For instance, bread is believed to have a eutectic point of −70° C.

At commercial freezing temperatures, a fraction of the water contained in foods remains unfrozen.

Because the eutectic point is limited as a tool for determining freezing effectiveness, many researchers look to the glass transition temperature, (Tg) which is the temperature at which a food undergoes a transition from the rubbery to the glassy state. When a food product passes from the rubbery state to the glassy state, the temperature is low enough so that the material between the ice crystals is extremely viscous and reactive substances cannot diffuse into the system. Consequently, most fast reactions stop at this point making the glassy state the point of greatest storage stability for a frozen product.

On the surface, the solution seems simple: a product's unique Tg can be determined analytically and product kept below that temperature to maintain optimum stability. A product's Tg, however, can be impractical to maintain. Solutions of sugars in water, for example, have Tg below −30° C. (−22 degrees Fahrenheit). Products that have a high sugar content will have a lower Tg than those with lower sugar content. However, adding a compatible copolymer with a higher Tg—such as maltodextrin—can raise the Tg of the mixture into the region of commercial frozen storage. At the very least, the Tg can be elevated enough to improve frozen storage.

While freezing occurs, heat is conducted from the interior of a food to its surface where it is removed by the freezing medium. The rate of heat transfer is influenced by many factors such as: the thermal conductivity of the food, the surface area of food available for heat transfer, the distance that the heat must travel (thickness), the temperature difference between the food and the freezing medium, the insulating effect of air surrounding the food and the presence of packaging material.

Not only is the heat transfer rate variable, calculating the freezing time is further complicated by differences in initial temperature of the food; differences in size and shape of individual pieces; differences in freezing point and the rate of ice crystal formation within various regions of the same piece of food; and changes in density, thermal conductivity, specific heat and thermal diffusity that occur as the temperature is reduced.

As water changes to ice, it releases approximately 80 calories per gram of latent heat which must be removed. A formula developed by Plank is often used to calculate freezing times for food products. The quality of a frozen food depends on the treatment it receives prior to freezing, how it is frozen, subsequent frozen storage and thawing conditions.

A number of physical changes occur during frozen storage of foods. Among these are phenomena involving growth in the average size of ice crystals mostly due to temperature fluctuations during storage discussed above.

Moisture migration also may be a problem during storage of frozen foods. Temperature gradients or differences will exist in a product due to temperature fluctuations. Water vapor pressure will be higher at higher temperatures than at lower temperatures, and moisture will relocate to the colder area(s) particularly at the surface or when there is a space or void.

This same mechanism is responsible for the “freezer burn” that can occur when frozen foods are poorly wrapped. Here, moisture migrates through the packaging material and disappears through sublimation leaving the product dried out.

For this reason, moisture often will accumulate on the product surface. If, and when the temperature gradient reverses, the moisture will not migrate back to its original location. It is for this reason that the present invention includes numerous water activity reducing agents in part to reduce moisture migration so as to minimize moisture sublimation and loss during frozen storage. Lower frozen storage temperatures are also encouraged, but the commercial provider has limited control of storage temperatures. Another way of reducing moisture migration and loss is to freeze the bakery products as quickly as possible by one of several “flash” freezing methods discussed below.

Bakery products offer special problems because of accelerated staling and moisture loss. Staling rate increases as temperature decreases until the aqueous phase is frozen and starch can no longer crystallize. In order to prevent staling it is necessary to bring the product through the temperature zone of +10° C. (50 degrees Fahrenheit) to −5° C. as rapidly as possible during the freezing process itself.

Broadly speaking, methods of “flash” freezing may be defined as either mechanical or cryogenic. Closed mechanical systems require a compressor, a condenser, an expansion valve and an evaporator. Cryogenic systems are open and use either liquid nitrogen, carbon dioxide or ambient air.

Further definitions of equipment under the mechanical category include “Sharp” type freezers which employ little or no air circulation and are usually used for storage rather than initial freezing although they may be used for freezing quarters of beef, butter or fish. Blast freezing involves moving cold air through the freezing area at a velocity of 100 to 400 meters/minute and is often used for institutional food service operations when complete meals are prepared for later use and delivery to other sites from a central kitchen.

A refrigerant commonly used for mechanical freezing systems is ammonia. Freon-12 is a fully halogenated chloroflurocarbon (CFC) and is being phased out of use due to its effect on the ozone layer. The Montreal international agreement of 1987 calls for cessation in use of CFCs by 1995. Substitutes such as CHClF₂ and CF₃CH₂F do not appear to be as satisfactory.

Mechanical freezing has a great operational savings advantage over cryogenic freezing because no costly nitrogen or carbon dioxide gas is lost to the atmosphere. Proponents of mechanical freezing methods doubt that there is enough of these two gases in the United States to produce all of the french fried potatoes needed to satisfy the fast food requirements of the country.

While the initial costs for a mechanical system are high, the operating cost for a mechanical system can run from ¼ to ½ cent per lb. of product processed. Mechanical freezing can be particularly economical for freezing cooked products with high heat loads.

IQF (individually quick frozen) and other systems involve intimate contact of the freezing medium with the product. Plate or contact freezing systems involve contact of the product on both sides with metal at freezing temperatures.

The IQF process is advantageous for small-sized particulate types of foods such as peas. One way in which IQF has been achieved is through the fluidized bed freezer which offers considerable saving in space requirements over tunnel or belt freezers. Fluidized belt freezing is particularly useful for products that tend to stick together such as French green beans or sliced carrots.

Fluidization is achieved by subjecting particles of uniform shape and size to an upwardly directed low temperature air stream. As a given air velocity is reached, the particles will be suspended in air and be free to move forward as more product is added. Thus a conveyor is not needed. This technique achieves very intimate contact between air and product and gives much better heat transfer than is achieved by tunnel or belt freezing.

Mechanical freezing systems can reach a temperature of only −40° C. Liquid nitrogen, on the other hand, boils at −196° C. and carbon dioxide sublimes at −78.5° C. In addition to being able to achieve colder temperatures, a cryogenic freezing system does not require a refrigeration plant as the compressed gas is received from suppliers.

In general, cryogenic freezing is used for high value, low volume products such as shrimp or berries. Nitrogen tends to be the gas of choice in the United States.

Both nitrogen and carbon dioxide tend to be relatively bacteriostatic. In addition, cryogenic freezing of raw product reduces dehydration (shrink) loss which may amount to as much as 3 to 6% with some mechanical air blast freezing systems.

One cryogenic method is to directly immerse product in liquid nitrogen. With this method, products may crack. Whether a food is prone to cracking depends on size, shape, porosity and density. Research has indicated that moisture content is not the primary indicator of cracking tendency.

The use of carbon dioxide for freezing to some extent depends on geographical availability. In some areas in the southern United States, carbon dioxide comes out of the ground from wells. In other areas it is available from an industrial feedstock, for instance, as a by-product of ammonia production for fertilizer. A large amount of power is required to produce liquid nitrogen.

Carbon dioxide at −18° C. extracts 135 BTU per lb., while nitrogen at −196° C. extracts 155 BTU per lb. There is a significant difference in the distribution of BTU between the states in which the freezing agents contact the product being frozen. Carbon dioxide exists at atmospheric pressure as either a solid or a gas. As a liquid, carbon dioxide is held under pressure. When the pressure is released the carbon dioxide comes out as a snow. This snow removes 85% of the BTUs while gas vapor removes 15%. With nitrogen, 48% of the BTUs are removed as the liquid expands and becomes a gas while the vapor removes 52% of the BTUs.

For this reason, a nitrogen freezing unit is set up so that the gas flows counter current to the product. The nitrogen is sprayed into the freezing unit with nozzles and evaporates on leaving the nozzles and contacting the product. Cold gas is circulated by means of fans toward the end of the tunnel or belt on which product is entering in order to pre-cool the product. The spent gas is exhausted at the front of the unit.

Carbon dioxide, on the other hand, is set up so that product and freezing medium flow in the same direction. Because the snow has to sublime, the point of injection is moved closer to where the product is to be frozen.

Carbon dioxide snow is often used for chilling as in manufacturing sausage type products. Because of the difference in physical properties and cooling mechanism, it is not possible to substitute either nitrogen or carbon dioxide for one another in a freezing system without making major modifications.

High heat transfers achieved at the surface and outer layers of a product through cryogenic means make the process ideal for foods that are sensitive to handling or are wet and sticky, such as late season strawberries. Often a product can be crust frozen by this means and then completely frozen by a mechanical system in order to cut costs.

Newer developments have resulted in equipment and a process employing ambient air as the freezing medium. The air is delivered at −157° C. into a spiral belt freezing chamber. The air is brought to this temperature by means of compression, heat exchange, and expansion. This system is said to provide cryogenic quality at mechanical costs.

Freezing food has often been considered an expensive process. This is actually not true when the cost of freezing and packaging in paperboard or plastic is compared with that of thermal processing and packaging in cans. In addition, long storage is not required for most food products due to rapid turnover caused by of consumer demand. An additional advantage is the high quality of most frozen foods.

The preferred bread dough composition disclosed in the following example was formulated to better illustrate the scope of the present invention. In the example below, the sucrose to fluid corn syrup ratio was 1.0:2.0 by weight, and the solid to liquid shortening ratio was 6.0:1.0 by weight.

### EXAMPLES

### Example 1

A bread dough composition having 50.00% flour, 32.40% water, 3.24% yeast, 0.81% salt, 2.03% solid shortening, 0.34% oil, 1.35% corn syrup, 0.67% sugar, 0.54% emulsifier, 1.62% flavoring, 0.47% encapsulated sodium bicarbonate, 1.12% baking powdered, 0.06% dough conditioner, 1.08% microwaveability enhancer, and 0.27% preservative, all measured by weight, were combined according to the method outlined above.

In a further embodiment of the present invention, the above-described raw bread dough of the disclosed composition is used to envelop an inner precooked filling material to produce an enrobed food product. The raw dough enrobed food product is then frozen for storage and distribution. Some examples of the precooked filling material include meat patties, soy patties, and hot dogs. Various condiments, such as catsup, mustard or relish can be added to and enveloped with the filling material by the raw dough prior to freezing.

The frozen dough enrobed food product is heated to simultaneously bake the enrobing dough and warm the precooked filling material prior to consumption. Where the heating employs microwave energy, the frozen dough enrobed food product is contained in an SBS container. The heating time for the frozen dough enrobed food product in a microwave oven is about 1.5 to 4.0 minutes, depending upon the size of the frozen dough enrobed food product. Similarly, the frozen dough enrobed food product can be placed directly on a sheet and baked in a conventional oven at about 450° F. for 12 to 15 minutes, again the baking time depending upon the size of the frozen dough enrobed food product.

The baked bread envelope resulting from heating of the frozen dough enrobed food product is tender and free from hard spots which can occur with other frozen dough. Where microwave heating is employed to bake the frozen dough enrobed food product, the enrobed food product is sprayed or brushed with an aqueous caramel coloring solution prior to freezing and packaging. A coloring material denoted as Maillose is available from Red Arrow Products Company, Manitowoc, Wis. When heated, the Maillose solution provides a brown, roasted color to the exterior of the baked dough of the enrobed food product.

### Example 2

Ten different frozen microwavable bakery or bread dough products are prepared by mixing the ingredients in any of the five columns (1-5) in either Table 1 or in Table 2 (see below). The ten frozen microwavable bread dough products are as follows: white bread (Table 1, Column 1); wheat bread (Table 1, Column 2); Sourdough Bread (Table 1, Column 3); dark rye bread (Table 1, Column 4); light pumpernickel bread (Table 1, Column 5); white sandwich bread (Table 2, Column 1); wheat sandwich bread (Table 2, Column 2); dark rye sandwich bread (Table 2, Column 3); sourdough sandwich bread (Table 2, Column 4) and light pumpernickel sandwich bread (Table 2, Column 5). In each case, there are differences in amounts which are reported in the respective tables. In the case of the bread doughs prepared according to the list of ingredients in Table 1, these products include a relatively substantial amount of a secondary “chemical” leavening agent, encapsulated sodium bicarbonate (50% sodium bicarbonate). In the sandwich bread products reported in Table 2, each product has a much less significant amount of the encapsulated sodium bicarbonate; however, they have an additional secondary leavening agent, double acting baking powder, which the bread products reported in Table 1 do not have. In addition, the bread products reported in Table 1 also include a further secondary leavening product, sodium aluminum phosphate (SALP). Furthermore, these preferred formulations have different emulsifiers. The bread products reported in Table 1 have an emulsifier from Watson Food Company, Inc., Westhaven, Conn. called EMG/SSL Blend, product no. F230100 and the sandwich bread products reported in Table 2 have an emulsifier called lactylate hydrate provided by Custom Ingredients, Ltd., New Braunfels, Tex.

The respective bread and sandwich bread products are prepared in the following manner. The ingredients are scaled out in six separate containers, one for flour, one for the yeast which needs to be kept away from the salt, another container for the remaining dry ingredients (salt, granulated sugar, sodium bicarbonate, SALP, Mikro Fresh, dough conditioners (Relax-A-Do 2), powdered flavoring and any other dry materials included in the particular formulation. In the fourth container, the liquids with the exception of water are scaled together. This includes the liquid pizza blend, all-purpose shortening, soybean oil, emulsifier and any other liquid materials included in the formulation that is being made. The water is scaled into yet another separate container. A further container is also required in which the ascorbic acid, calcium iodate and prozyme tablets are dissolved in a small portion of the water taken from the previously mentioned container. Once the ingredients are properly measured into these respective containers, they may be added into a mixture in the following order: (1) crumble the yeast and put into the mixing bowl; (2) add the flour and mix with the yeast; (3) add the remaining dry ingredients to the mixture of the flour and the crumbled yeast and continue to mix them together; (4) add in the liquid ingredients which do not as yet include the water and also add the aqueous solution of ascorbic acid, prozyme and calcium iodate. Start mixing at a very slow speed, slowly add the remaining water while the mixer is running. When there is no longer any dry flour in the bowl, mix the dough at a higher speed and continue to add in any remaining water, allowing the dough to continue to mix until the dough is extensible. This is generally determined by stretching a small amount of dough between the hands. Once a transparent film is obtained the dough is extensible. This will take anywhere between five to eight minutes, but it is dependent upon when the dough becomes extensible. After the dough is extensible and the mixing is stopped, the dough is taken out of the bowl, divided, rounded, and shaped.

TABLE 1
Frozen Microwavable Bread Dough Products

| Ingredients (Percent by Weight | 1 | 2 | 3 | 4 | 5 |
|---|---|---|---|---|---|
| High Protein Flour (13.7% + 0.3% | 50.39 | 38.16 | 49.16 | 37.04 | 48.76 |
| Prot.) | | | | | |
| Wheat Flour (15.0 + 0.3% Prot.) | | 8.18 | | | |
| Dark Rye (13.8% + 1.0% Prot.) | | | | 12.35 | |
| Yeast | 4.03 | 4.36 | 3.93 | 3.95 | 3.90 |
| Salt | 0.76 | 0.82 | 0.74 | 0.74 | 0.73 |
| Granulated sugar (sucrose) | 0.63 | 0.68 | 0.61 | 0.62 | 0.61 |
| Encapsulated Sodium Bicarbonate - | 2.02 | 2.18 | 1.97 | 1.98 | 1.95 |
| 50% | | | | | |
| Mikrofresh | 1.26 | 1.36 | 1.23 | 1.24 | 1.22 |
| Sourdough Flavoring | 2.52 | 2.73 | 4.92 | | 2.44 |
| Deli Rye Flavoring | | | | 3.95 | |
| Light Pumpernickel Flavoring | | | | | 1.28 |
| SALP* | 1.01 | 1.09 | 0.98 | 0.99 | 0.98 |
| Dough Conditioners (Relax-a-do) 2 | 0.09 | 0.10 | 0.09 | 0.09 | 0.09 |
| Emulfifier | | | | | |
| EMG/SSL | 1.01 | 1.09 | 0.98 | 0.99 | 0.98 |
| Lactylate Hydrate | | | | | |
| Liquid Pizza Blend | 5.04 | 5.45 | 4.92 | 4.94 | 4.88 |
| All Purpose Shortening | 1.89 | 2.04 | 1.84 | 1.85 | 1.83 |
| Soybean Oil | 0.63 | 0.68 | 0.61 | 0.62 | 0.61 |
| Black Strap Molasses | | | | | 1.95 |
| Water | 28.72 | 31.08 | 28.02 | 28.16 | 27.79 |
| Carmel Coloring | | | | 0.49 | |
| Ascorbic Acid (% of a Tablet) | 33 | 33 | 33 | 33 | 33 |
| Prozyme (% of a Tablet) | 12.5 | 12.5 | 12.5 | 12.5 | 12.5 |
| Calcium Iodate (% of a Tablet) | 25 | 25 | 25 | 25 | 25 |

*Sodium Aluminum Phosphate, Acidic (NaAl₃H₁₄(PO₄)₈O) from Watson

TABLE 2
Enrobed Sandwich Bread Dough Products

| Ingredients (Percent by Weight | 6 | 7 | 8 | 9 | 10 |
|---|---|---|---|---|---|
| High Protein Flour (13.7% + 0.3% Prot.) | 51.38 | 43.66 | 35.68 | 49.71 | 49.67 |
| Wheat Flour (15.0 + 0.3% Prot.) | | 7.72 | | | |
| Dark Rye (13.8% + 1.0% Prot.) | | | | 11.90 | |
| Yeast | 3.34 | 3.34 | 3.09 | 3.23 | 3.23 |
| Salt | 0.77 | 0.77 | 0.71 | 0.75 | 0.75 |
| Granulated sugar (sucrose) | 0.65 | 0.65 | 0.60 | 0.63 | 0.63 |
| Encapsulated Sodium Bicarbonate - 50% | 0.45 | 0.45 | 0.41 | 0.43 | 0.43 |
| Mikrofresh | 1.28 | 1.28 | 1.19 | 1.24 | 1.24 |
| Sourdough Flavoring | 1.80 | 1.80 | 4.97 | | 1.74 |
| Deli Rye Flavoring | | | | 3.81 | |
| Light Pumpernickel Flavoring | | | | | 1.31 |
| Double Acting Baking Powder | 1.06 | 1.06 | 0.98 | 1.03 | 1.03 |
| Dough Conditioners (Relax-a-do) 2 | 0.03 | 0.03 | 0.03 | 0.03 | 0.03 |
| Emulfifier | | | | | |
| EMG/SSL | | | | | |
| Lactylate Hydrate | 0.84 | 0.84 | 0.78 | 0.81 | 0.81 |
| Liquid Pizza Blend | 5.14 | 5.14 | 4.76 | 4.97 | 4.91 |
| All Purpose Shortening | 1.93 | 1.93 | 1.79 | 1.87 | 1.87 |
| Soybean Oil | 0.51 | 0.51 | 0.48 | 0.50 | 0.50 |
| Black Strap Molasses | | | | | |
| Water | 30.82 | 30.82 | 33.31 | 29.83 | 29.80 |
| Carmel Coloring | | | | | |
| Ascorbic Acid (% of a Tablet) | 100 | 100 | 100 | 100 | 100 |
| Prozyme (% of a Tablet) | 50 | 50 | 50 | 50 | 50 |
| Calcium Iodate (% of a Tablet) | 25 | 25 | 25 | 25 | 25 |

In Table 1, there are a series of five different examples of frozen microwavable bread dough products set forth in each of the respective columns. The example described in column 1 is a white bread formulation; the example set forth in column 2 is a wheat bread formulation; the example set forth in column 3 is a sour dough bread formulation; the example set forth in column 4 is a dark rye bread formulation and the example set forth in column 5 is a light pumpernickel bread formulation. Each of these breads are formed into loaves and proofed at from about 115 to about 118° F. until approximately a third preferably generally about 30 to 35% of the yeast capacity is activated and the dough has risen from about 30 to about 35% of the rise which would occur if the proofing were continued until completion of the yeast leavening capacity in the dough. The respective loaves are then frozen, by reducing the temperature to less than 0° F. The panned product (i.e., bread, buns or sandwich) is placed on a conveyor belt, then sent through a nitrogen tunnel to be flash frozen. This process can take about 30 seconds to about 20 minutes dependent upon the size of the dough piece and the amount of product going through the freeze tunnel. In preferred embodiments, liquid ammonia, liquid nitrogen or frozen carbon dioxide can be used in such a flash freezing operation and the frozen microwavable bread dough product is preferably stored in a sub-zero freezer at about −10° F. In preferred embodiments, the frozen microwavable bread dough product is frozen in a manner which reduces the temperature of the product quickly to −10° F. and the product may then be packaged for shipment to the consumer or consumer outlets in appropriate frozen storage containers.

When the frozen microwavable bread dough product is prepared for consumption, is taken out of frozen storage and place directly in an oven, preferably a microwave oven, where it will be heated from about one to about six minutes depending upon the size of the product. In preferred embodiments, the product is held within a common white SBS board container in which the product may be cooked in a microwave oven. During microwave heating, the temperature is raised to more than 140° F. and the remaining yeast is activated and the frozen microwavable bread product will rise further. In addition, the encapsulated sodium bicarbonate will also release carbon dioxide which further leavens the product to allow a further rise. Some additional leavening is also provided by the SALP (sodium aluminum phosphate).

In preferred embodiments, the flour will contain from about 12 to about 16% by weight of protein. The protein is essential to provide the needed adhesion to provide a desired open grain structure which is common to other bread products. The protein is believed to bind together to at least partially encapsulate gases generated during the leavening process to result in the larger open grain structure anticipated in bread products. While normal bread may only have from about 8 to about 9% protein, it is generally proofed and then baked in a simpler process which does not involve freezing, frozen storage or microwave cooking. It is believed that the partial proofing of the present invention, prior to flash freezing and frozen storage, allows the preferred embodiment of the present invention to develop its open grain structure which is further enhanced during cooking following frozen storage. During cooking subsequent to frozen storage, whether in a microwave oven or in other conventional cooking ovens, the remaining leavening capacity due primarily to the remaining inactivated yeast, but also in part to encapsulated sodium bicarbonate, results in further leavening. That causes the bread to continue to rise after frozen storage.

It is an objective of the present invention to provide a frozen microwavable bakery product having an open grain structure of the type normally associated with bread products, wherein the moisture in the frozen microwavable bakery product is bound at least in part to water activity reducing agents such as corn syrup, sucrose, and water binding emulsifiers such as sodium stearoyl-2 lactylate (SSL); calcium stearoyl-2 lactylate (CSL), ethoxylated monoglycerides (EOM); Datem; sucrose esters; polysorbate 60; mono- & diglycerides; succinylated monoglycerides; lecithin; lactylate hydrate and the like. Preferred corn syrups include HI-SWEET 42 High Fructose Corn Syrup from Roquette America, Inc., Gurnee, Ill.; ROCLYS A3680R 36DE/43 Baume Corn Syrup from Roquette America, Inc., Gurnee, Ill.; and the like. Preferred Imitation Vanilla is purchased from Flavorchem and contains water, propylene glycol, artificial flavors and caramel color. Amber Sweet is the preferred Liquid Sucrose and it is purchased from Sweetener Supply Corporation, Brookfield, Wis.

In preferred embodiments of the present invention, from about 0.2 to about 0.8% by weight of caramel coloring may be added, preferably about 0.5% by weight. Preferred caramel colorings include an aqueous solution of caramel coloring made from corn dextrose and salt under the name MAILLOSE™ coloring which is a liquid and can be included in the liquid ingredients; a powered caramel coloring agent from Gold Coast (product no. 900640) or other similar caramel coloring agents. Prozyme is preferably obtained from Watson Food Co., Inc., Westhaven, Conn., in prozymetabs, product no. F100013, which includes fungal proteases and fungal amylase enzymes edible excipients such as corn starch, sodium acid, pyrophosphate, sodium bicarbonate, microcrystalline cellulose, talc, silica or the like. Prozyme contains a blend of enzymes designed to both increase the available level of sugars to the yeast and increase the extensibility of the gluten to provide for more relaxed and machinable doughs. Calcium iodate tablets are also obtained from Watson Food Co., Inc., Westhaven, Conn. in the form of iotabs, product no. F100021, which contains sufficient calcium iodate to add 20 ppm calcium iodate to 100 pounds of flour. The ingredients include calcium iodate, dicalcium phosphate and salt. Calcium iodate tablets provide an oxidizing agent which is designed to increase loaf volume and improve crumb structure. Ascorbic acid tablets are preferably provided in the form of ascorbitabs 30, product no. F10003, from Watson Food Co., Inc., Westhaven, Conn. Ascorbitabs 30 function as an oxidizing agent and are designed to increase loaf volume and improve crumb structure.

There are some variations in the proofing of the various products. In relation to the bread products reported in Table 1, one pound loaves are prepared and they are proofed at a temperature of from 110 to 115° F. in a proofing box in which the relative humidity is maintained at 50% for a period of 18 minutes. In the sandwich bread formulations reported in Table 2, the dough is cut into three ounce segments generally the size of a hamburger bun and they are proofed at a temperature of from 110 to 115° F. at a relative humidity of 500 for a period of 14 minutes.

In each case, the products are removed from the proofing boxes and frozen in order to preserve a portion of the leavening capacity of the dough, preferably 65 to 70% of the normal leavening capacity needed to generate a further rise of the product during cooking following frozen storage.

While the invention has been particularly shown and described with reference to preferred embodiments thereof, it will be understood by those skilled in the art that various changes in form and details may be made therein without departing from the spirit and scope of the invention.

What is claimed is:

1. A method of preparing a cooked bread product from a frozen microwavable dough product comprising:
a. removing the frozen microwavable dough product from frozen storage; and
b. without prior thawing of the frozen microwavable dough product, heating the frozen microwavable dough product in a microwave for a sufficient time to cook the frozen microwavable dough product, thereby preparing the cooked bread product;
wherein the heating causes a further rise of from about 80 to about 40% of the projected rise of a comparable unfrozen dough product.

2. The method of claim 1, wherein a convection or conventional oven is used to heat the frozen microwavable dough product.

3. The method of claim 1, wherein the heating causes a further rise of from about 70 to about 60% of the projected rise of the comparable unfrozen dough product.

4. The method of claim 1, wherein the frozen microwavable dough product comprises:
a. from about 40 to about 58% of a cereal grain flour;
b. from about 2.0 to about 7.0% by weight of baker's yeast;
c. from about 0.5 to about 1.0% by weight salt;
d. from about 0.5 to about 3.0% by weight granulated sucrose;
e. from about 0.5 to about 1.5% by weight of an emulsifier;
f. from about 1.0 to about 4.25% by weight of a shortening;
g. from about 0.2 to about 1.5% by weight of a food grade oil;
h. from about 4 to about 8% by weight of a blend of sweeteners, the blend of sweeteners comprising from about 30 to about 100% by weight of corn syrup; from about 0.1 to about 70% by weight liquid sucrose; and from about 0.1 to about 10% by weight imitation vanilla; and
i. from about 25 to about 60% by weight water.

5. The method of claim 4, wherein the frozen microwavable dough product further comprises from about 1.0 to about 1.4% by weight of a microwavability enhancer.

6. The method of claim 5, wherein the frozen microwavable dough product further comprises from about 1.1 to about 1.35% by weight of a microwavability enhancer.

7. The method of claim 5, wherein the microwavability enhancer comprises enriched bleached flour, cellulose powder, modified food starch, carboxymethylcellulose, xanthan gum, and vegetable shortening.

8. The method of claim 4, wherein the frozen microwavable dough product further comprises from about 2.0 to about 6.0% by weight of flavoring components.

9. The method of claim 4, wherein the frozen microwavable dough product further comprises from about 0.5 to about 1.5% by weight of a further leavening product.

10. The method of claim 9, wherein the further leavening product is selected from double acting baking powder, and sodium aluminum phosphate.

11. The method of claim 4, wherein the frozen microwavable dough product further comprises from about 0.01 to about 0.20% by weight of a dough conditioner.

12. The method of claim 11, wherein the dough conditioner comprises wheat starch, 1-cysteine hydrochloride, and ammonium sulfate.

13. The method of claim 4, wherein the emulsifier is selected from the group consisting of EMG/SSL, lactylate hydrate, and hydrated sodium stearoyl lactylate.

14. The method of claim 4, wherein the blend of sweeteners includes from about 40 to about 90% by weight of corn syrup.

15. The method of claim 14, wherein the blend of sweeteners includes from about 60 to about 80% by weight of corn syrup.

16. The method of claim 15, wherein the blend of sweeteners includes about 70% by weight of corn syrup.

17. The method of claim 4, wherein the corn syrup is selected from 36 DE corn syrup, light corn syrup, and mixtures thereof.

18. The method of claim 4, wherein the blend of sweeteners includes from about 0 to about 70% by weight of a liquid disaccharide.

19. The method of claim 18, wherein the blend of sweeteners includes from about 10 to about 50% by weight of a liquid disaccharide.

20. The method of claim 19, wherein the blend of sweeteners includes from about 20 to about 40% by weight of a liquid disaccharide.

21. The method of claim 20, wherein the blend of sweeteners includes about 30% by weight of a liquid disaccharide.

22. The method of claim 20, wherein the liquid disaccharide comprises liquid sucrose.

23. The method of claim 4, wherein the blend of sweeteners comprises 63% by weight of 36 DE corn syrup, 8% by weight of a light corn syrup, and 28% by weight liquid sucrose.

24. The method of claim 4, wherein the blend of sweeteners further includes from about 0.1 to about 10% by weight imitation vanilla.

25. The method of claim 4, wherein the dough further comprises from about 1.8 to about 2.35% by weight encapsulated sodium bicarbonate.

26. The method of claim 1, wherein the frozen microwavable dough product is cooked in the microwave without susceptor packaging materials.

27. A method of preparing a cooked bakery product from a frozen microwavable bakery product comprising:
a. removing the frozen microwavable bakery product from frozen storage; and
b. without prior thawing of the frozen microwavable bakery product, heating the frozen microwavable bakery product in a microwave for a sufficient time to cook the frozen microwavable bakery product, thereby preparing the cooked bakery product;
wherein the heating causes a further rise of from about 80 to about 40% of the projected rise of a comparable unfrozen bakery product.

28. The method of claim 27, wherein the frozen microwavable dough product further comprises an enrobed center portion, wherein the contents of the enrobed center portion include foods selected from the group consisting of meat, cheese, tomato sauce, condiments, and vegetables; thereby forming a frozen microwavable bakery product.

29. The method of claim 28, wherein the frozen microwavable bakery product is a sandwich.

30. The method of claim 27, wherein the frozen microwavable bakery product is cooked in the microwave without susceptor packaging materials.

31. The method of claim 27, wherein a microwave is used to heat the frozen microwavable bakery product.

32. The method of claim 27, wherein a convection or conventional oven is used to heat the frozen microwavable bakery product.

33. A method of preparing a cooked bread product from a frozen microwavable dough product comprising:
a. removing the frozen microwavable dough product from frozen storage; and
b. without prior thawing of the frozen microwavable dough product, heating the frozen microwavable dough product in a microwave without susceptor packaging materials for a sufficient time to cook the frozen microwavable dough product, thereby preparing the cooked bread product;
wherein the heating causes a further rise of from about 80 to about 40% of the projected rise of a comparable unfrozen dough product.

34. A method of preparing a cooked bakery product from a frozen microwavable bakery product comprising:
a. removing the frozen microwavable bakery product from frozen storage; and
b. without prior thawing of the frozen microwavable bakery product, heating the frozen microwavable bakery product in a microwave without susceptor packaging materials for a sufficient time to cook the frozen microwavable bakery product, thereby preparing the cooked bakery product;
wherein the heating causes a further rise of from about 80 to about 40% of the projected rise of a comparable unfrozen bakery product.

35. A method of preparing a cooked bread product from a frozen microwavable dough product comprising:
a. removing the frozen microwavable dough product from frozen storage; and
b. without prior thawing of the frozen microwavable dough product, heating the frozen microwavable dough product in a microwave for a sufficient time to cook the frozen microwavable dough product, wherein the frozen microwavable dough product rises during cooking, thereby preparing the cooked bread product;
wherein the heating causes a further rise of from about 80 to about 40% of the projected rise of a comparable unfrozen dough product.

36. The method of claim 35, wherein the rise during cooking is from about 70 to about 60% of the projected rise of the comparable unfrozen dough product.

37. A method of preparing a cooked bakery product from a frozen microwavable bakery product comprising:
a. removing the frozen microwavable bakery product from frozen storage; and
b. without prior thawing of the frozen microwavable bakery product, heating the frozen microwavable bakery product in a microwave, wherein the frozen microwavable dough product rises during cooking, thereby preparing the cooked bakery product;
wherein the heating causes a further rise of from about 80 to about 40% of the projected rise of a comparable unfrozen bakery product.

38. The method of claim 37, wherein the rise during cooking is from about 70 to about 60% of the projected rise of the comparable unfrozen dough product.
